(19) United States
(12) Patent Application Publication
(10) Pub. No.: US 2016/0363932 A1
(43) Pub. Date: Dec. 15, 2016

(54) WORKSITE MONITORING SYSTEM

(71) Applicant: Caterpillar Paving Products Inc., Brooklyn Park, MN (US)

(72) Inventors: Brian G. Moriarity, Big Lake, MN (US); Brett M. Meyer, Maumelle, AR (US); Julie J. Ruffcorn, Champlin, MN (US); Robert M. Brainerd, Maple Grove, MN (US); Donald W. Barkman, Maple Grove, MN (US)

(73) Assignee: Caterpillar Paving Products Inc., Brooklyn Park, MN (US)

(21) Appl. No.: 15/248,997

(22) Filed: Aug. 26, 2016

(51) Int. Cl. G05D 1/00; B64C 39/02

(52) U.S. Cl. CPC G05D 1/0033; B64C 39/024; B64C 2201/127

(57) ABSTRACT

A worksite monitoring system is provided. The worksite monitoring system includes a machine operating at a worksite. The worksite monitoring system also includes an information network associated with the machine. The worksite monitoring system further includes an Unmanned Aerial Vehicle (UAV) communicably coupled to the information network. The UAV including a control module and an image capturing device. The UAV is adapted to receive a feed of machine information related to one or more activities associated with the machine via the information network. The UAV is also adapted to identify if surveillance of the machine is required based on the received feed. The UAV is adapted to fly to the location of the machine based on the received location of the machine. The UAV is also adapted to surveil an area proximate to the machine by capturing visual data of at least one of the area and the machine.

### TECHNICAL FIELD

The present disclosure relates to a worksite monitoring system, and more particularly to the system for monitoring a number of machines operating at a worksite.

### BACKGROUND

A number of different machines operate at a worksite. Surveillance of the machines is important from worksite security and compliance point of view. At large worksites or at worksites that are difficult to access, it becomes troublesome for a personnel to check the machines from security point of view as well as to check whether the machines are operating in an intended manner. It is essential that an operator seated at a remote location is made aware of any undesirable machine activity that may affect productivity of the machine or the worksite.

Currently available surveillance systems are costly and complicated. Further, some surveillance systems are inefficient in monitoring abnormal activities of the machines at the worksite which may weaken the worksite security, create compliance issues, and cause loss in an overall productivity of the worksite.

U.S. Pat. No. 7,299,130 describes methods and apparatuses for surveillance of a convoy. At least one Unmanned Aerial Vehicle (UAV) obtains images around the convoy's position to provide information about potential hostile activity while the UAV follows a generally curvilinear path around the convoy as instructed by one of the convoy vehicles. Path planner algorithm software is executed by the controlling convoy vehicle in which position and velocity information regarding the unmanned aerial vehicle and the convoy are processed to determine values of control variables. The determined values are sent to the unmanned aerial vehicle over a wireless communications channel. The path of the surveillance vehicle may be changed in order to provide evasive measures to avoid an attack on the surveillance vehicle by an adversary.

### SUMMARY OF THE DISCLOSURE

In one aspect of the present disclosure, a worksite monitoring system is provided. The worksite monitoring system includes a machine operating at a worksite. The worksite monitoring system also includes an information network associated with the machine. The worksite monitoring system further includes an Unmanned Aerial Vehicle (UAV) communicably coupled to the information network. The UAV including a control module and an image capturing device. The UAV is adapted to receive a feed of machine information related to one or more activities associated with the machine via the information network. The UAV is also adapted to identify if surveillance of the machine is required based on the received feed. The UAV is further adapted to receive a signal indicative of a location of the machine based on the identification. The UAV is adapted to fly to the location of the machine based on the received location of the machine. The UAV is also adapted to surveil an area proximate to the machine by capturing visual data of at least one of the area and the machine using the image capturing device. The UAV is further adapted to transmit the captured visual data for remotely controlling one or more machine functions associated with the machine.

Other features and aspects of this disclosure will be apparent from the following description and the accompanying drawings.

### BRIEF DESCRIPTION OF THE DRAWING

FIG. 1 is a perspective view of an exemplary worksite, according to various concepts of the present disclosure; and

FIG. 2 is a block diagram of a worksite monitoring system associated with the worksite of FIG. 1, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

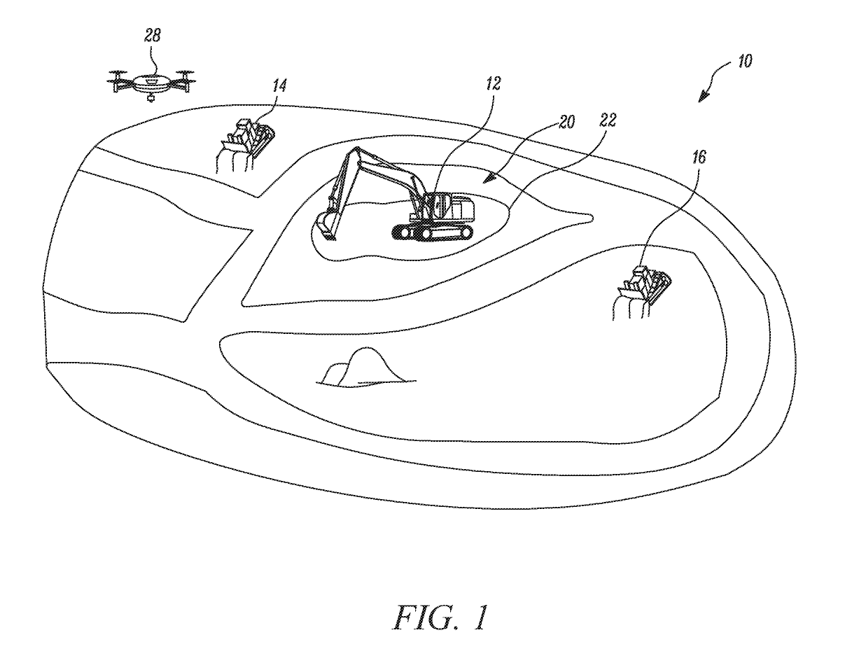

Referring to FIG. 1, a perspective view of an exemplary worksite 10 is illustrated. The worksite 10 may include a mining worksite, such as an underground mining worksite. Alternatively, the worksite 10 may include any other construction worksite known in the art, without limiting the scope of the present disclosure.

A number of machines 12, 14, 16 may operate at the worksite 10. A type of the machine 12, 14, 16 may vary based on a type of operation that needs to be performed at the worksite 10. Accordingly, the machines 12, 14, 16 may include, but is not limited to, an excavator, a wheel loader, a backhoe loader, a track type tractor, a shovel, a drilling machine, a hammer, and the like. For explanatory purposes, three machines 12, 14, 16 are shown operating at the worksite 10, however, the number of machines operating at the worksite 10 may vary based on system requirements. The machine 12 is embodied as an excavator and the machines 14, 16 are embodied as track type tractors.

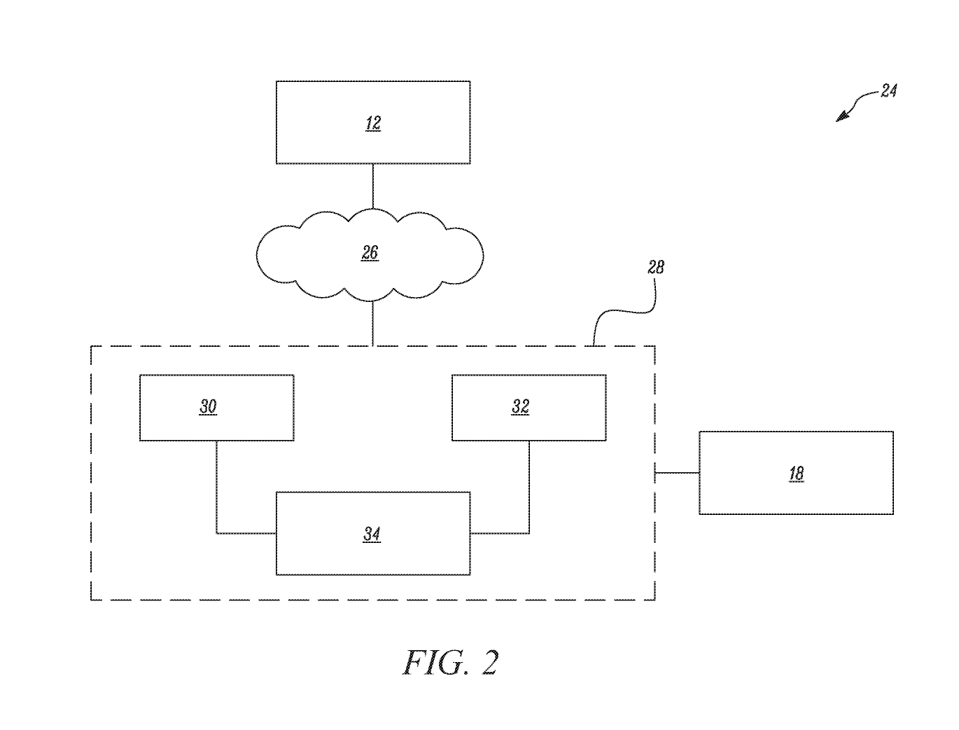

The machines 12, 14, 16 may be autonomous, semi-autonomous, or manually operated. In an example in which the machines 12, 14, 16 are autonomous or semi-autonomous, an operator seated at a remote location 18 (see FIG. 2) may operate the machines 12, 14, 16. The remote location 18 may include a base station that is located at the worksite 10 or at a location that is distant from the worksite 10.

The present disclosure is directed towards a worksite monitoring system 24 (see FIG. 2). The worksite monitoring system 24 monitors or surveils the worksite 10 and the machines 12, 14, 16 operating at the worksite 10 to ensure worksite security and functioning of the machines 12, 14, 16 in an intended manner. The worksite monitoring system 24 will now be explained in detail. For explanatory purposes, the worksite monitoring system 24 will be explained in reference to the surveillance of the machine 12, without any limitations. However, it should be noted that the worksite monitoring system 24 also monitors the machines 14, 16, or any other machine that operates at the worksite 10, without limiting the scope of the present disclosure.

Referring to FIG. 2, the worksite monitoring system 24 includes an information network 26 associated with the machine 12. The information network 26 is communicably coupled to the machine 12 and the remote location 18. In one example, each of the machines 12, 14, 16 operating at the worksite 10 (see FIG. 1) includes an information network associated therewith. In an alternate example, each of the machines 12, 14. 16 share a common information network.

The information network 26 may receive Global Positioning System (GPS) coordinates of the machine 12 on a real time basis. The information network 26 also receives instructions to operate the machine 12 from the operator seated at the remote location 18. Further, the information network 26 transmits the operational instructions to the machine 12.

Further, the information network 26 receives feed of machine information from the machine 12 for access of the machine information by other components or systems connected to the information network 26, such as the remote location 18. The feed of machine information is related to one or more activities associated with the machine 12. The feed may include any discrepancy of machine operation from its intended manner of operation. For example, if the machine 12 starts, stops, moves, or performs any activity in a way that the machine 12 should not be doing at that time, the information network 26 may receive the feed of such machine information.

The feed may also include information regarding any damage caused to the machine 12 during operation, any accident at a location 20 (see FIG. 1) at which the machine 12 is operating, non-utilization of the machine 12 to its full capacity, etc. Further, the feed may include information pertaining to heavy use or use of the machine 12 beyond its capacity, a temperature of one or more components of the machine 12 being beyond permissible limits, a speed of the machine 12 being greater than a predetermined machine speed, etc.

The information network 26 may embody a network that is capable of receiving and transmitting information from the machine 12 at the worksite 10 and the remote location 18, without limiting the scope of the present disclosure. The information network 26 may include, but is not limited to, a wide area network (WAN), a local area network (LAN), an Ethernet, an internet, an intranet, a cellular network, a satellite network, or any other network for transmitting data between the machine 12 and the remote location 18. In various examples, the information network 26 may include a combination of two or more of the aforementioned networks and/or other types of networks known in the art. The network may be implemented as a wired network, a wireless network, or a combination thereof. Further, the data may be transmitted over the information network 26 with a network protocol, for example, in an encrypted format, or any other secure format known in the art.

Referring to FIGS. 1 and 2, the worksite monitoring system 24 also includes an Unmanned Aerial Vehicle (UAV) 28. The UAV 28 is communicably coupled to the information network 26, and is capable of receiving the feed of machine information from the information network 26. In one example, the UAV 28 may embody a commercial drone that hovers at the worksite 10. The UAV 28 may embody any powered, aerial vehicle without a human pilot aboard that hovers at the worksite 10. The UAV 28 may be remotely operated by the operator at the remote location 18 or it can be autonomous or semi-autonomous. The range and altitude of the UAV 28 may be decided based on the requirements at the worksite 10.

Referring to FIG. 2, the UAV 28 includes an image capturing device 30. The image capturing device 30 is embodied as any known visual data capturing device for capturing visual data of the worksite 10, the machine 1 or the location 20 at which the machine 12 operates. For example, the image capturing device 30 may include any optical instrument for recording and/or image capturing. The image capturing device 30 may embody a still camera, a camcorder, a video camera, a Closed-Circuit Television (CCTV) camera, and the like. The image capturing device 30 is mounted at a location on the UAV 28 such that the image capturing device 30 captures clear and obstruction free visual data.

In other embodiments, the image capturing device 30, the UAV 28 may include additional components (not shown) such as a GPS receiver, Inertial Measurement Units (IMU), etc., that are required for functioning of the UAV 28, without limiting the scope of the present disclosure. The UAV 28 also includes a power source (not shown) that powers the UAV 28.

The UAV 28 includes a light emitting device 32. In one example, the light emitting device 32 may be mounted proximate to the image capturing device 30. The light emitting device 32 may include Light Emitting Diodes (LED's), Liquid Crystal Displays (LCD's), Organic Light-Emitting Diodes (OLED's), or any other light source known in the art. The light emitting device 32 is used to illuminate the worksite 10, the machine 12, and/or or the machine location 20 (see FIG. 1).

In one example, the illumination provided by the light emitting device 32 allows the image capturing device 30 to capture clear and bright visual data in low light conditions. In another example, the light emitting device 32 may be used to distract a person who attempts to breach the worksite security. Further, the light emitting device 32 may also be used to illuminate the machine location 20 in low light conditions.

Further, the UAV 28 includes a control module 34. The control module 34 is communicably coupled with the image capturing device 30 and the light emitting device 32. The control module 34 is also communicably coupled with the information network 26 and the remote location 18. The control module 34 is capable of processing signals from each of the image capturing device 30, the light emitting device 32, the information network 26, and the remote location 18.

The control module 34 may embody a single microprocessor or multiple microprocessors. Numerous commercially available microprocessors can be configured to perform the functions of the control module 34. The control module 34 may include all the components required to run an application such as, for example, a memory, a secondary storage device, and a processor, such as a central processing unit or any other means known in the art. Various other known circuits may be associated with the control module 34, including power supply circuitry, signal-conditioning circuitry, solenoid driver circuitry, communication circuitry, and other appropriate circuitry.

The control module 34 receives the feed of machine information related to the activities associated with the machine 12, via the information network 26. Also, the control module 34 identifies if the machine 12 requires surveillance, based on the received feed of machine information. More particularly, if the control module 34 detects any discrepancy in the operation of the machine 12 from its intended manner of operation, the control module 34 identifies that the machine 12 requires surveillance.

The control module 34 detects the discrepancy in the operation of the machine 12 by comparing the feed of machine information with pre-defined machine data pertaining to the operation of the machine 12. In one example, a database (not shown) may be associated with the control module 34. The database may store the pre-defined machine data. The control module 34 may retrieve the pre-defined machine data from the database as and when required in order to identify whether the machine 12 requires surveillance.

Based on the identification of the requirement of surveillance, the control module 34 receives a signal indicative of the machine location 20 from the information network 26. Alternatively, the control module 34 may receive the signal indicative of the machine location 20 from an active GPS system at the worksite 10. Further, the UAV 28 receives commands from the control module 34 to fly to the machine location 20 at the worksite 10. Accordingly, the control module 34 transmits the machine location information and a flight path to the UAV 28.

On reaching the machine location 20, the UAV 28 surveils an area 22 proximate to the machine 12 by capturing visual data of the area 22 and/or the machine 12 using the image capturing device 30 and the light emitting device 32. The control module 34 receives the visual data captured by the image capturing device 30. Further, the control module 34 transmits the captured visual data to the remote location 18 for remotely controlling one or more machine functions associated with the machine 12. For example, the operator seated at the remote location 18 may send signals to halt the machine 12, stop operation of the machine 12, or instruct personnel or patrolling officers to visit the machine 12 for further inspection, based on system requirements.

Referring to FIGS. 1 and 2, the UAV 28 of the worksite monitoring system 24 disclosed herein may perform surveillance of the worksite 10 in three modes, i.e., a watchdog mode, a service aide mode, and/or a security patrol mode. In the watchdog mode, the control module 34 receives the feed of machine information from the information network 26 and identifies whether the machine 12 requires surveillance. The feed may include information regarding starting, stopping, moving, or any activity in a way that the machine 12 should not be doing at that time. For example, the control module 34 of the UAV 28 may identify a theft situation and the UAV 28 will fly to the machine location 20 and use the image capturing device 30 and the light emitting device 32 to capture the visual data of the area 22 and/or the machine 12. Further, the control module 34 transmits the visual data of the area 22 and/or the machine 12 to the remote location 18. Thus, the operator seated at the remote location 18 may be made aware of the real time situation at the worksite 10. Further, in a theft situation, the light emitting device 32 may also distract a potential thief by illuminating the area 22 and/or the machine 12.

In the service aide mode, the control module 34 receives the feed of machine information from the information network 26. Based on the received feed, the control module 34 identifies surveillance requirements of the machine 12. The feed may include information such as the damaged condition of the machine 12, usage of the machine 12 beyond its capacity, any accident encountered by the machine 12, the temperatures of one or more components of the machine 12 being beyond permissible limits, the speed of the machine 12 being greater than the predetermined machine speed, etc.

Further, on identification of the surveillance requirement, the UAV 28 may fly to the machine location 20 and capture the visual data of events occurring at the machine location 20. Further, the control module 34 transmits the captured visual data to the remote location 18. Based on the received visual data, the operator at the remote location 18 may send a signal to shut down the machine 12 or dispatch personnel to the machine location 20 for inspection purposes.

In the security patrol mode, the UAV 28 flies over the worksite 10 and patrols the entire worksite 10 and all the machines 12, 14, 16 (see FIG. 1) operating at the worksite 10. More particularly, the UAV 28 performs a security check function of the entire worksite 10. In some examples, the UAV 28 may be fed with instructions to periodically perform the security patrol. For example, the UAV 28 may fly to the worksite 10 after a set time interval, in order to capture the visual data of the activities of the machines 12, 14, 16 at the worksite 10. Further, the control module 34 of the UAV 28 may transmit the captured visual data of the worksite 10 or the machines 12, 14, 16 to the remote location 18, thereby providing sufficient data to the operator for taking corrective measures, if required.

### INDUSTRIAL APPLICABILITY

The present disclosure relates to the worksite monitoring system 24. The worksite monitoring system 24 allows surveillance of the worksite 10 as well as individual machines 12, 14, 16 that operate at the worksite 10. The worksite monitoring system 24 makes use of the information network 26 to transmit the feed of machine information to the UAV 28. Since the machines 12, 14, 16 are already equipped with the information network 26, the worksite monitoring system 24 does not incur any additional cost in facilitating the information network 26 for receiving and transmitting the feed of machine information.

The worksite monitoring system 24 is a time and cost efficient system for surveillance at the worksite 10. The worksite monitoring system 24 provides effective worksite security as the worksite monitoring system 24 operates on a real time basis. The worksite monitoring system 24 allows surveillance of areas at the worksite 10 that are difficult to access on a regular basis. Further, the worksite monitoring system 24 allows monitoring of machine activities and reports any undesired machine activity to the remote location 18, so that the operator/personnel at the remote location 18 may take corrective measures.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A worksite monitoring system comprising:
a machine operating at a worksite;
an information network associated with the machine; and
an Unmanned Aerial Vehicle (UAV) communicably coupled to the information network, the UAV including a control module and an image capturing device, wherein the UAV is adapted to:
receive a feed of machine information related to one or more activities associated with the machine via the information network;
identify if surveillance of the machine is required based on the received feed;
receive a signal indicative of a location of the machine based on the identification;
fly to the location of the machine based on the received location of the machine;
surveil an area proximate to the machine by capturing visual data of at least one of the area and the machine using the image capturing device; and
transmit the captured visual data for remotely controlling one or more machine functions associated with the machine.
